(19) United States
(12) Patent Application Publication
(10) Pub. No.: US 2010/0049577 A1
(43) Pub. Date: Feb. 25, 2010

(54) SYSTEM AND METHOD FOR CONTROLLING A PROJECT TASK

(76) Inventor: Stephen McGowan, Leeds (GB)

Correspondence Address: HEAD, JOHNSON & KACHIGIAN, 228 W 17TH PLACE, TULSA, OK, 74119, US

(21) Appl. No.: 12/439,569

(22) PCT Filed: Aug. 29, 2007
(86) PCT No.: PCT/GB2007/003252

§ 371 Date: Sep. 11, 2009

(30) Foreign Application Priority Data
Aug. 30, 2006 (GB) 0617061.7
Mar. 1, 2007 (GB) 0703912.6

(51) Int. Cl. G06Q 10/00; G06F 3/048; G06Q 50/00

(52) U.S. Cl. 705/9; 715/772; 705/11; 705/7; 707/104.1

(57) ABSTRACT

The invention relates to a system and method for monitoring and controlling the performance of a task, such as for example, the construction of a building. The specific modules required to complete the task are identified and, in turn, the functions required to complete each module are identified. The performance of each function, the time taken to perform the function and other features are monitored. Typically the next function in each module cannot be performed until the previous function in that module has been accepted. An efficient and structured performance of the task is therefore achieved.

### CROSS-REFERENCE TO RELATED APPLICATIONS

This application is the United States National Phase of PCT-GB/2007/003252 filed 29 Aug. 2007, which claims priority to British Application No. 0617061.7 filed 30 Aug. 2006 and to British Application 0703912.6 filed 1 Mar. 2007, each of which is incorporated by reference herein.

### STATEMENT REGARDING FEDERALLY SPONSORED RESEARCH OR DEVELOPMENT

Not Applicable

### THE NAME OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The invention to which this application relates is a method and system for controlling effectively and efficiently, the progress and financial implications of a project task (hereinafter referred to as a task) and in particular, although not necessarily exclusively, a construction task.

Tasks, and particular construction tasks, can be of many different forms and have many different variations, but typically, they relate to a series of items of work which are needed to be performed by a range of different skilled persons and in a required sequence in order to allow the overall construction task to be completed.

For example, in a construction task in the form of a building, the building will typically comprise a plurality of rooms. Each of the rooms will require skilled craftsmen to perform a range of functions in order for the room to be completed, and the same, or a different, combination of functions will be required to be completed for each of the rooms so that the overall construction task can in due course be completed.

It is often found that the requirement for different functions to be performed, requires different organisations and companies to be used to perform the same. It is also found that if one function is not completed in due time, then the next function cannot be commenced, and so on, which can lead to delays being incurred in the completion of the room, and, as a knock-on result, delays in the overall construction task. The delays can be caused simply by overrunning in the completion of a particular function by a particular company or organisation, and/or subsequent problems in performing the next function due, perhaps, due to unavailability of personnel, or materials and/or the overrun of the previous function and so on.

The cost of overrunning on a construction task can be significant and initially, typically the main contractor will have to bear the costs which are incurred. The main contractor may then look to attribute at least a portion of those costs onto subcontractors and/or other organizations or companies who performed the particular functions which caused the delays and hence the cost to be incurred. Unfortunately, it is found using conventional methods and systems that there is no proper and uniform system whereby a main contractor can firstly, easily identify the cause of the delays, and secondly prove that the delays were caused by a particular company or organization. It should also be appreciated that because of the size of the costs and damages which can often be sought, the onus is very much on the organization claiming the costs or damages to prove that they should be provided with payment.

These problems can often lead to difficulties for main contractors, subcontractors and/or other organizations or companies who are required to claim damages or costs from persons whom they have contracted.

An aim of the present invention is to provide a method and system whereby firstly, the progress of a task can be assessed over time and secondly, to provide a method whereby a historical record is created and retained of a particular task thereby allowing the attribution of certain issues which occur during the task to be effectively and efficiently allocated to particular organizations, companies and/or personnel.

In a first aspect of the invention, there is provided a method for monitoring a task, said method comprising the steps of assessing the task, splitting the task into a series of predefined modules; analyzing each module and, if necessary, splitting the modules into a series of functions which are required to be performed in order to complete the module, and, for each function, storing information relating to the commencement of the function in the module, receiving and recording information relating to the completion of the function in the module; checking that the function has been completed and, if the function has been completed satisfactorily, authorizing the start of the next function for that module and if not, informing the person or organization who performed the function.

Typically this method is repeated for each of the functions in each of the modules.

Typically the said modules and functions and at least some of the information relating thereto is shown graphically in a combined manner.

In a further preferred embodiment, if the function has started and the projected completion date for the function is passed before the completion of the function is approved, the graphical representation is changed for that particular function to indicate whether the same has been completed in time or not. In one embodiment this may be by indicating for that function the number of days for completion of the function and the color of the number will indicate whether the number of days is over schedule or not.

In one embodiment, if any particular function completion overruns the projected date of completion, then the completion date for at least that module and subsequent functions to be performed on that module, can be recalculated.

In one embodiment, the construction modules can be allocated as respective rooms of a building and the task is the construction of the building.

Typically, each function in each module, is required to be checked and approved as completed before the next function in that module can be commenced. In a preferred embodiment, the date upon which completion is approved is entered onto the graphical interface for that specific function.

In a preferred embodiment, the graphical interlace includes a reference to accompanying documents which relate to the approval of the completion of that function and hand-over and/or any other necessary documents such as safety certificates, guarantees or the like. In this way a unique identifier can be provided for each function and the paperwork relating to the same as allocated to that identifier.

In one embodiment, the graphical representation includes a series of different colors allocated to the functions, to represent progress made in the task. In one embodiment a particular color will relate to a particular time interval, such as a week, and those functions which are completed in that week will all be the same color. The functions completed in the next week will be of a different color and so on.

In accordance with the invention, there is therefore provided a method which allows a record of the progression of a task to be provided, for the task to be split into a series of modules and for those modules to be split into the required functions which are required to complete the module and hence in turn, the construction task. Furthermore, the graphical interface allows a representation of those functions which are completed, and those which are overrunning and therefore provides an immediate indication of critical parts of the task.

In a further aspect of the invention there is provided a task controlled in accordance with the method as herein described and wherein such task is a construction task.

Furthermore, the method provides a record of the task completion, which record can be referred to subsequently, as it provides a record of what actually occurred during the task and this can be referred to when attempting to attribute damages and costs. The record can, in one embodiment, include links to other relevant documentation.

In one embodiment, the functions include a design stage and the graphical representation will indicate if there are any design issues to refer to and these design issues may then be referred to. The functions may also include a snagging function at the end of each particular module if required.

In one embodiment, the design function can include a status report per module, a visual design status report on the preparation of the drawings for the design and these may be provided as part of a main graphical interface or a separate graphical interface linked to a main graphical interface.

In one embodiment, the system includes a document issuance and recording function which allows, preferably in an automated manner, the issuing of documents at particular stages of a function, module or overall construction task. In one embodiment, a series of reports can be provided which may include the issuance of letters to contractors indicating a function that is late in completion with regard to an allocated time, an indication of a function completed early to the contract time and/or an indication of completion of a function in line with the contract time. The issuance of these documents can be used to provide a record to the person or organization who is performing, or has performed, the function and also the overall construction task organization.

In a preferred embodiment, the document is generated after a check on the completion of a particular function and said document will indicate whether the completion has been accepted or rejected along with any relevant survey details.

Further documents may also be generated with regard to the quality of the completion of the function and typically these documents, along with any reasons for rejection, are generated once the data relating to the check of completion has been input into the system database from which database the graphical interface can be coated. It is also preferred that the graphical interface will change condition for each function once the check has been completed and the completion of the function has been accepted.

Other documents which may be generated are any of, an accelerating cost letter indicating to contractors the amount which will be taken from their account if a particular function runs over a contract time, and/or a delay notice which may be generated to a sub-contractor to indicate that other trades, i.e. other organizations or companies, are being delayed by their lateness in completing a function.

Another document may be generated to indicate costs which will be deducted due to damage which has been incurred and/or costs which will be deducted for the need to revisit the function to recheck the same.

Furthermore, a document may be generated to indicate that liquid associated damages will be deducted from an account due to a lack of performance, such as the completion of the function running over the time.

Furthermore, a document may be generated indicating a notice period if the subcontractor does not improve productivity and/or an official notice and/or an official letter saying that they will be removed from site due to lack of productivity.

In a further aspect of the invention, there is provided a system to control and represent the progression of functions in particular modules of a task, said system including a database holding data relating to the scheduled and real time progression of the task, a display screen via which a graphical interface is created, said interface including a table showing one or more modules of the task and an indication as to whether a particular function for each of the modules shown has been completed or not at a given time.

In one example, if each module is a room, then the table is provided in the form of a floor plan showing a number of rooms (modules). Then, in accordance with this aspect, for each function which is required for those rooms, the user can select one of the functions. Typically those modules or rooms for which the function has been completed, will be shown in a first form and those rooms or modules for which the function has not been completed at the time of the request are shown in a second form so as to allow a user to immediately identify the progression of a particular function for a particular range of modules.

Typically a graphical representation of this form can be generated for each function and will show for example, a floor plan of rooms or modules.

It will therefore be appreciated that part of the invention is that upon the entry of information relating to the completion of a function into the database of the system, appropriate documentation can be generated automatically to provide records of the same, both to the contractor in charge of the construction task and also to any relevant sub-contractor to therefore ensure that they all have the same information at the same time.

In one embodiment there can be provided an automated update procedure in which the schedule can be changed to reflect the progression of the functions as the work progresses. Thus at any time a selection can be made to change the scheduled completion dates at which stage the same will be redated and amended.

In a further embodiment of the invention a system is incorporated that automatically sets start dates and completion dates for a set of functions to start and when all the functions are to be complete. This can be used for individual companies or individuals. The system can work in any organization where there is a time line which is linked to the completion of a task.

The system divides the time line by the number of functions which have to be completed in the specific time interval. The completion of the functions and quality of the same can be checked and, when accepted as complete, the system can check that the correct number of functions are completed in the correct time interval.

Where there are multiple functions to be completed to achieve the overall last, the overall time interval is divided into allocated time intervals for each function. This allows the system to calculate the number of functions that need to be completed to achieve the task in the allotted time, for example;

100 functions to be completed in 10 weeks;
3 units of work per function;

Therefore there are 3×100=300 units to be completed in the 10 weeks to achieve the 100 completed functions as a whole;

This means the required completion to achieve the target is 30 units per week.

Where there is any effect on the original time scale either positively or negatively, a calculation of time difference relating to the effect can be inserted into the original time interval showing the effect on the time interval and showing the cause and effect of the influence. With each influence on the time line having its own unique number, each influence, and the cause and effect it has on the time interval, is full accountable.

The system can then track if tasks and the functions are therefore completed in the necessary time.

This can be used for single time line or, where there are multiple time lines for a number of different functions to be completed.

With regards to multiple modules, each having functions to be completed, the system can be instructed to start the following function in any module once a certain percentage of the previous function is complete this will then remove the need to have a start date for each function, the only requirement needed would be that a start date and completion date for all the tasks it is given.

In a further embodiment of the invention, the system and method may include an automated correspondence system which automatically sends and saves correspondence relating to the previous function with regards to work completed, quality and/or damage. Other correspondence may be added where it is to advantage or information regarding status of a contract or the like.

The correspondence can be set to different sending times. This could be when a task is fully completed by the function or when each individual room/location has been completed. Thus the correspondence can be sent when either 1% of the previous function is complete all the way through to when 100% of the function is completed. At the same time inspection reports and damage reports can be attached to the correspondence to make the information available.

In addition to the above there is also the possibility of generating automated letters which can be preset to be issued when inspecting for quality and damage. When the allotted percentage has been reached then the system can automatically send the appropriate correspondence to the company who performed the function.

In one embodiment the letters may require a password to be entered before the correspondence can be sent. This is particularly useful of the letter is to contain contentious material.

In a further embodiment the system may include a financial programme to allow valuations for tasks modules and/or functions to be obtained. The system can issue valuations on the works that have been completed and have been passed by the checking system. In one embodiment an indication can be generated with regard to the representation to allow cash flow forecasts and true valuation forecasts for individual contractors and the overall task to be created.

In one embodiment a drawing recognition system is included. In one embodiment this allows architects or designers to draw each design of a floor plate in which a room identification will be placed. Once the drawings/designs are complete the system will be able to recognise the outline of each room/location and the identification tag, to allow automatic input of data.

In one embodiment the architects or client will input room data sheets and specifications and the system will then be able to recognise this information and transfer it into the main data base.

### BRIEF DESCRIPTION OF THE DRAWINGS

A specific embodiment of the invention is now illustrated with reference to the accompanying drawings, wherein:—

FIG. 1 illustrates an example of a graphical interface, in accordance with the invention, for a construction task comprising a series of work modules; and

FIG. 2 illustrates one work module of the type shown in FIG. 1 with a series of functions.

### DETAILED DESCRIPTION OF THE INVENTION

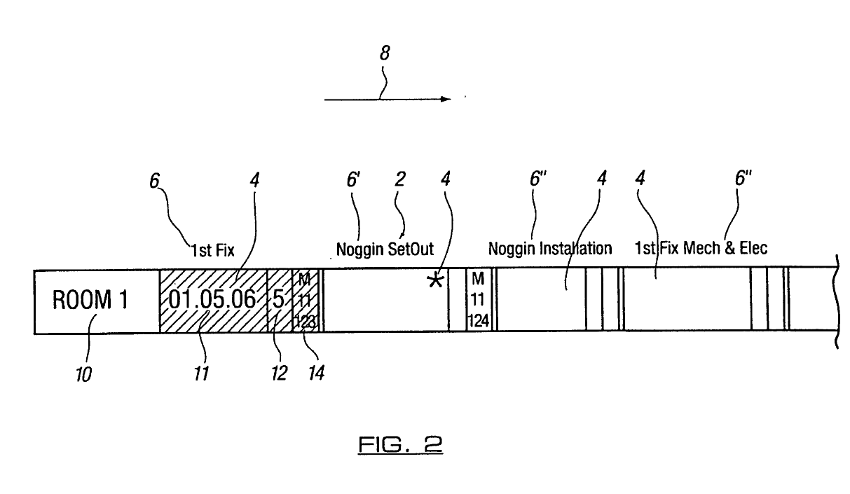

Referring firstly to FIG. 2, there is illustrated a work module 2 in accordance with an embodiment of the invention. A work module is a description given to a specific area or location within an overall construction task such as, in this example, room 1 of the building. This work module 2 is then split into a series of functions 4 which are required to be completed, in order for the construction task for that module to be complete. Furthermore, each of the functions is provided in the order in which the same have to be completed from left to right indicated by arrow 8.

Thus, the graphical interface includes a module name 10. The first function in FIG. 2 is a 1st Fix 6 followed by a Noggin set out 6′, Noggin installation 6″, 1st Fix mechanical and electrical 6″, and so on until all of the functions which are required for the module to be completed, have been included.

In the example shown, in FIG. 2, the construction of the module is partway through and this is indicated by the fact that the first function is provided of a first colour to indicate the time period in which the function was completed (herein indicated by a first form of hatching). The particular function 6′ which is underway at the present time, is provided with an indication (in this case an asterisk *). The functions which are still to be performed are, in this case, blank. It should also be noticed that for those functions which have been completed, the completion date is indicated 11. This completion date represents the date at which the job for that function was checked and signed off. This would normally occur after the contractor performing the function, has informed the main contractor that in their view they have completed the same, a check would then be undertaken to assess whether the function has in fact been completed and, if so, the date of acceptance is included and the number of days 12 for completion input. The color of the number can be selected as appropriate such that a first colour indicates if the function was completed on or ahead of time and second colour is selected if the number of days for completion was greater than the scheduled number of days for completion.

Also, a further column 14 is provided for each function 4 which allows a reference to be included which will be carried by all documentation generated for that function. This allow the easy retrieval of that documentation as and when required and the reference can be generated at the start of the function and as shown in the case of the function 6′ in one embodiment this can be used as an indication of the function which is being worked on at that time, rather than the asterisk.

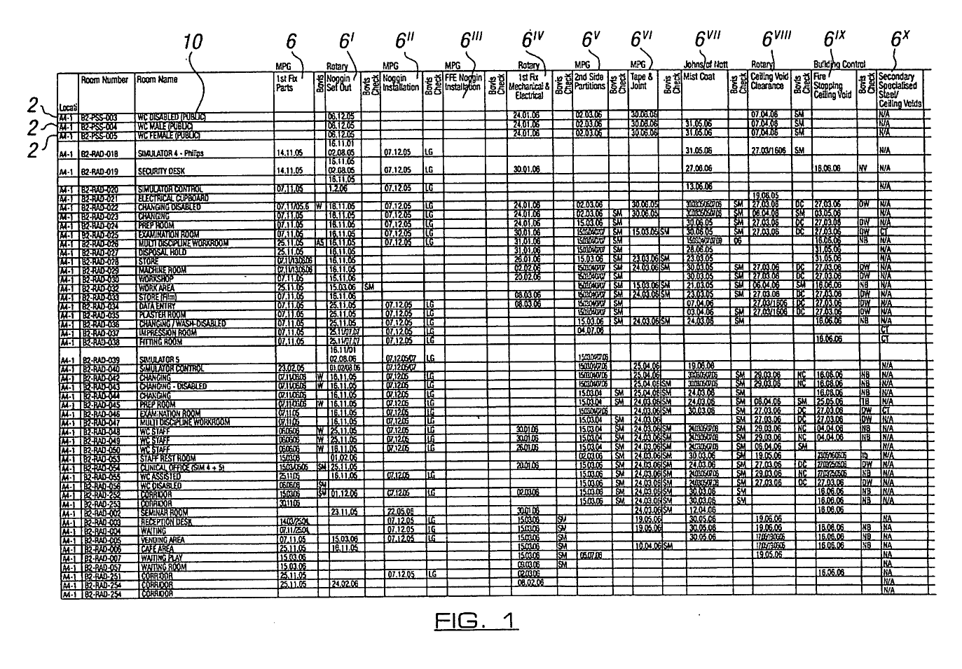

Thus, in accordance with the invention, each of the functions can be combined into a graphical interlace as shown in FIG. 1. It will therefore be seen that in this case there are a plurality of rooms or modules 2, each having a series of functions 6-6^{x} defined in a row leading therefrom. Each module 2 is dealt with independently and therefore each function in that module has to be cleared and checked and accepted as being completed before being signed off. The combination of the modules 2 into one graphical interface as shown, allows an overall impression to be quickly gained as to the progression of the construction task. The provision of different graphical displays for functions which have been completed over time, or are over time and have still to be completed, means that quickly, these areas can be identified and, if necessary, remedial action taken with regard to the subcontractors who are causing the delay. As previously discussed, the remedial action may include the automated sending of necessary warning letters at the required time so as to ensure that the problem is dealt with efficiently and quickly.

In addition to the above features, the method may also include the ability to update and reschedule the graphical representations based on actual occurrences in terms of completion of functions. Thus, if for example a number of functions run over time, then the user of the system can select to reschedule and update the graphical representation for the ongoing functions to take into account the actual occurrence of completion and times on which the completion of functions have occurred. This therefore provides to the user, a realistic and up-to-date schedule of ongoing functions and provides future dates which are in synchronisation with events as the actually occur. If appropriate, it may also allow the period of days allocated for completion of functions and modules, to be amended to try and take into account the delays which have been caused in previous functions and thereby allow the target completion date for the overall construction tasks to still be achieved.

In one example, the system monitors the task program from the day of commencement and allows at a very early stage the highlighting of any problems which are occurring and/or could create difficulties in the future. This could be any or any combination of client/design sub-contractor/staffing levels/skill levels/productivity etc.

The system does this by taking reference of the original contracted time for each sub-contractor. The task is then split into modules such as, for example, each floor of a structure, which can then be split into rooms and then, in one embodiment, into two phases.

The phases can be the route the construction process will follow and the rooms are the locations inside the phases. The rooms can be represented by grid lines if there are relatively large areas of open floor space.

For example, if a contractor states that they can complete 100 rooms in 16 weeks and there are 4 phases the contractor is stating that they can complete a phase in 4 weeks which would be 25 rooms. For example, if the sub-contractor is dry lining they have three processes in their works, 1st fix, 2nd fix and then tape and jointing. This would mean the company would have to complete 75 processes in four weeks to complete the 25 rooms. So therefore the system would expect the contractor to hand over complete 18.5 processes per week. If this is not achieved then the contractor is not handing over enough completed works to finish his contracted works to keep up with the allocated 16 week period.

This calculation is made for every sub-contractor and their works are monitored and show if they are oil time to program. At a very early stage the system will highlight if the contractor is performing as they should be, and allows decisions to be made on how to proceed, as the provision of the phases in the overall task allow monitoring to be maintained during the procedure rather than waiting until the finish date is reached, or not. For example, if a variation in the time scale is identified which will lead to the time schedule being overrun the system allows this data to be input into the system and an indication indicated on the display. Also if the variation has an input on further functions which have to be performed then the time schedule will be altered and the effect passes through the overall schedule. Furthermore the cause of the variation is identified.

As each process is handed over, a check is typically carried out for quality. An inspection of the room can also be performed and any damage to the room is noted.

In one embodiment the personnel making the checks may use a PDA/scanner and when a check is made and approval provided or denied the data from the device can be automatically down loaded. The system assesses the data and sends correspondence to the relevant contractor stating the damage which has occurred along with the acceptance or rejection of the room. A copy can also be sent to the quantity surveyor who can then issue the instruction for the previous contractor to re-enter and correct the damage. This enables full recovery of costs regarding damages.

Agreement can be made at the start of the contract that the damage report can be an official instruction to start work, if this is agreed by the parties involved then when the automated correspondence is sent an additional one can be sent to the previous sub contractor as an instruction to re-enter and repair the works damaged.

This process will allow all damages to any location to be properly accounted for and legally deducted from the relevant contractor who has damaged the room. This will ensure the works are instructed and completed in the quickest possible time and without any delay to the contact time.

Typically, when the personnel are to undertake the check, upon entering the room in question the operative will swipe a bar code with his hand held bar code scanner/PDA. This will automatically find the room in question.

In the device are a list of checks which have to be completed before the works will be accepted as complete. These can be added to and also deleted if not required, in the same check there will be the specification for that room (i.e plaster board moisture resistant green) and the data sheet (i.e 2 low level sockets, 1 light switch).

The system is first set at 100% checks. i.e. a check will be done one all rooms/areas. However, if over time it is found that a contractor offers works complete to the standard which is required. The check system may automatically reduce to 75%, 50%, 25% checks of the overall rooms/areas, but as soon as the contractor offers rooms/locations to a sub-standard level the system will automatically revert to the 100% check.

Only when the check is 100% accepted as complete will the system issue instructions to the next contractor to commence their works. This process ensures that a contractor will only enter a location when they can finish all of that particular process which they have been instructed to commence.

This ensures quality is achieved to the highest standard and is kept at that level with rewards to the contractors who keep their works at the required level. The system will also reduce the massive amount of cost and labor which is generally attained in the last 15% of a contract.

Locations can be identified by their own unique bar code which is scanned on entry to the area/location. At present this is the standard way of room identification.

Additional methods are available for this process which would mean replacing the bar code strip with a micro-chip. The micro-chip would enhance the identified process as once positioned it can be covered by build materials, thus saving the replacing of the bar code strip which has to be done at present as the build moves forward.

It is also possible to use GPS to find the locations; this in some cases can be very difficult with sensors having to be placed all round the contract so the PDA could pick up the satellite signal. Typically a particular task will be surveyed and assessed if this requirement is needed.

With the program monitored as stated above the system will automatically adjust the construction program showing where the task will finish if productivity is kept at the present level, tracer times are left behind to show how the construction program is moving due to the productivity of all parties involved.

It is also possible to bring the contract back on time to the finish date by clicking and highlighting the phases which the contractor feels he wants to accelerate. Once highlighted, the system will recalculate the time required and adjust the nominated contractor's time scale to bring the product back on schedule.

As a result certain contractors may be accelerated and the cost of this can be reimbursed from the contractor/contractors creating the delay.

All correspondence and checks are preferably uniquely numbered and each operative carrying out the checks has their own signing reference which then makes it possible to see the amount of work individuals are carrying out, also with the financial design phases monitored this ensures all are doing their job at the correct time and are not affecting the contract.

The system sets the required number of processes for each sub contractor to complete his works in a specific time. If this is not achieved then productivity levels may be too low which could mean an increase in labor or at the worst the sub-contractor cannot cope with the amount of work.

In addition to issuing reports the system can in one embodiment issue floor plate drawings for each process if required. This will show works completed and will show works which should have been completed but are not.

With all aspects monitored the system will issue reports on everything from awaiting client approval to sub-contractors behind on program.

Once the system is running and the checks are being carried out the system will automatically issue correspondences for work to commence/damage/works not excepted. Also issued will be quality warnings and productivity warnings and damage reports. The correspondence can be selectively issued in that the correspondence may in one embodiment be issued when a function is 100% completed, 50% completed and so on.

These correspondences in one embodiment will be contractual letters where a company is flailing in its obligations to the contract and creating difficulty for everyone else. These have to be sent but will not be sent automatically due to the content and nature of the correspondence.

With the system monitoring and checking every aspect of the construction from concept to design all audits are covered from the client's requirement to minimize the amount of risk that a main contractor has to account for.

In another embodiment of the invention, if a company has a number of contracts or tasks simultaneously ongoing the system can provide a combined representation of the progression of each of these tasks. For example, if three tasks are on time, one is in front of program, and one is behind program it is possible to represent the system to the company who may then choose to redirect the labor from the contract that is in front and accelerate the contract that is behind without having any effect on the overall completion dates of the company. This gives the flexibility to the company which is only possible via the system, and yet ensures all works are complete at the required time and minimizing the risk to that company.

It should be noted that these features do not need to be limited to use with construction tasks and that other forms of tasks within an organization may be monitored and represented in this manner.

Each task may be monitored in real time and the system can be linked to its own server where specific information is down loaded regarding each individual task. When a combination of tasks are performed at different geographical locations, this can be indicated. For example, when a specific country is highlighted the system zooms in on the country and shows the regions. In these regions there is data regarding number of sites status of one that are behind on time, in front. These appear in the region with red, green and yellow dots. When the operative clicks on the dot the full tracking system for that task at that location is brought forward.

This enables the checking in time of how any particular contract/region/country is performing.

The system can also provide details on which contractors are doing well globally by issuing reports regarding the best achieving process. For example if in the USA, the design capability was achieving the best results and in Britain the design capability was number 5 in the table, then a comparison of how design capability is implemented and carried out in the USA and in Britain can be undertaken. The British system then can be altered to match the USA's method and this then improves the design stage in Britain. This allows the sharing of knowledge globally and in any process of construction which in turn and makes the company more efficient and effective in the global market place.

The system will issue reports with regard to specific tasks, tasks on a regional, national or international basis on how a company is performing regarding projects on time and in difficulty.

There is therefore provided a system and method of monitoring the performance of a task which can be easy to use, and allows the same to be used by personnel with different requirements such as architects, quantity surveyors, project managers and the like. The system can also be used to give a “live” as well as a scheduled indication of the progression of the task as a whole, individual modules of the task and features of the same. The provision of this allows problems to be identified relatively quickly, the input of the same to be assessed and action taken as appropriate such as the issuance of correspondence to contractors who may be failing in their performance.

1. A method for monitoring a task, said method comprising the steps of: assessing the task;
splitting the task into a series of predefined modules;
analyzing each module and, if necessary, splitting the modules into a series of functions which are required to be performed in order to complete the module;
for each function, storing information relating to the commencement of the function in the module; and
receiving and recording information relating to the completion of the function in the module, checking that the function has been completed and, if the function has been completed satisfactorily, authorizing the start of the next function for that module and, if not, informing the person or organization who performed the function.

2. The method according to clam 1 wherein said method is repeated for the functions in each of the modules until the task is completed.

3. The method according to claim 1 wherein said modules and functions and at least some of the information relating to the progression thereof is shown graphically on a display screen.

4. The method according to claim 3 wherein the information relating to each of said modules is shown in combination to provide an overall view of the performance of the task.

5. The method according to claim 1 wherein if the function is started and the projected completion date for that function is passed before the completion of the function is approved, a graphical representation is developed for that particular function to indicate the scheduled completion time and the actual completion time.

6. (canceled)

7. The method according to claim 5 wherein if any particular function completion overruns the projected date of completion, then the completion date for at least that module and each of subsequent functions to be performed for that module are recalculated.

8. The method according to claim 1 wherein the task relates to the construction of a building or part thereof.

9. (canceled)

10. The method according to claim 1 wherein each function is required to be checked and approved as completed before the next function in that module can be commenced.

11. (canceled)

12. The method according to claim 1 wherein a graphical interface is generated to represent the progression of the task and said interface includes access means to allow accompanying documents which relate to the approval or completion of each of the functions to be reviewed.

13. (canceled)

14. The method according to claim 1 wherein a graphical representation is generated to represent the performance of the task and said representation includes a series of different colors allocated to the function to represent progress made.

15. (canceled)

16. A method for charting the progress of a task, said method comprising the steps of splitting the task into a series of modules and, identifying for each module the functions required to be performed to complete the module, splitting the module into the required functions.

17. The method according to claim 16 wherein the method provides a record of the task completion, which record can be referred to subsequently provide a record of activities occurring during the task which can be referred to when attributing damages and costs.

18. (canceled)

19. (canceled)

20. The method according to claim 1 wherein said method includes a document issuance and recording function which allows the issuing of documents at particular stages of a function, module or overall task.

21. (canceled)

22. A system to control and represent the progression of a task with respect to functions in particular modules of a task, said system including a database holding data relating to the scheduled and real time progression of the functions and modules of the task, a display screen via which a graphical interface is displayed representing said task, modules and/or functions, said interface including a table showing one or more modules of the task and whether a particular function for each of the modules is completed or not at that given time.

23. The system according to claim 22 wherein each module represents a room of a building.

24. (canceled)

25. The system according to claim 22 wherein for each room the user can select one of the functions required to be performed for completion of that room and those modules or rooms for which the function has been completed can be shown on the interface.

26. (canceled)
